(19) United States
(12) Patent Application Publication
(10) Pub. No.: US 2024/0354387 A1
(43) Pub. Date: Oct. 24, 2024

(54) Biometric Recognition Across Distributed Assets

(71) Applicant: Cerence Operating Company, Burlington, MA (US)

(72) Inventors: Mark Kane, Burlington, MA (US); Brian Rubin, Montreal (CA)

(21) Appl. No.: 18/629,178

(22) Filed: Apr. 8, 2024

Related U.S. Application Data
(60) Provisional application No. 63/460,646, filed on Apr. 20, 2023.

(51) Int. Cl. G06F 21/32; G06V 40/16

(52) U.S. Cl. CPC G06F 21/32; G06V 40/168

(57) ABSTRACT

A method includes customizing interaction of a person with a vehicle from a fleet of vehicles by receiving, from an access controller in the vehicle, biometric data, the biometric data having been acquired from the person; using the biometric data, retrieving a profile for the person; and providing the profile to the vehicle. This enables the vehicle to transition into, or be reconfigured into, a state that enables the person to interact with the vehicle in a manner based on the profile.

### CROSS-REFERENCE TO RELATED APPLICATIONS

This application claims priority to U.S. Provisional Application No. 63/460,646 filed on Apr. 20, 2023, the entire content of which is incorporated by reference.

### BACKGROUND

There exist cases in which one has multiple assets distributed across space. An example of such a case is a rental car business or car-sharing service in which one has assets (i.e., cars) that are disposed at various locations. An inherent aspect of such a business is that of providing access to one but not all of those assets.

In a conventional method, the customer comes to a central office, fills out paperwork, and receives a key. At the central office, one can inspect a driver's license and confirm the driver's identity. Although this method is simple and secure, it does have a disadvantage, namely the inconvenience of having to maintain a central repository of vehicles.

In another conventional method, which is widespread in the car sharing industry, a customer has an access card that establishes wireless communication with a vehicle. In such cases, the vehicle communicates with a central server to confirm that access is authorized and unlocks itself if it is appropriate to do so. This eliminates the need for a central repository of cars and permits distribution of cars over a wide area.

On the other hand, anybody can hold the access card. Thus, there is no way to tell if the person driving the car is the same person who was granted permission to drive the car.

### SUMMARY

The invention provides a way to remotely grant access to one of a plurality of assets in a way that provides some assurance that the person receiving access is the same person to whom access was granted.

In one aspect, the invention features a method that includes customizing a person's interaction with a vehicle from a fleet of vehicles. In such a method, customizing the interaction comprises receiving, from an access controller in the vehicle, biometric data, the biometric data having been acquired from the person; using the biometric data, retrieving a profile for the person; and providing the profile to the vehicle. This enables the vehicle to transition into, or be reconfigured into, a state that enables the person to interact with the vehicle in a manner based on the profile.

In some practices, identifying the person comprises obtaining reference data for comparison with the test data. This reference data comprises information indicative of facial features of the person. Among these practices are those in which the reference data is data that was provided by the person during an enrollment process. Also among these practices of the method are those in which the reference data is data that has been obtained by the cloud service from publicly available images of the person.

Further practices include those in which receiving the test data comprises receiving test data that is based on an image of the person that was obtained by an internal camera of the vehicle while the person was inside the vehicle, those in which receiving the test data comprises receiving test data that is based on an image of the person that was obtained by an external camera of the vehicle while the person was outside the vehicle, and those in which receiving test data that is based on an image of the person that was obtained by an external camera of the vehicle while the person was approaching the vehicle.

Still other practices include those in which receiving the test data is not carried out by the vehicle. Among these are practices in which receiving the test data comprises receiving test data that is based on an image of the person that was obtained by a camera of a smartphone. In such cases, the image is typically one that was acquired as a result of a photograph taken of the person by using the smartphone, for example by using the smartphone to take a selfie.

Further practices include those in which, after the person has been identified, the seating within the vehicle is adjusted based on the profile. These include one or more of adjusting the seat's height, its position along the vehicle's longitudinal axis, and the seat back's angle.

Also among the practices are those in which, after the person has been identified, various settings in an infotainment system of the vehicle are based on the profile. These include such adjustments as resetting stored radio stations or including preferred audio settings for such parameters as treble or bass.

Still other practices include those in which a person uses the same profile in two different vehicles from a fleet. In such practices, the vehicle is a first vehicle of a fleet that comprises a second vehicle. Such practices include receiving, from an access controller in the second vehicle, test data, the test data being representative of an image of the person's face, using the test data, identifying the person, after having identified the person, retrieving a profile for the person and providing the profile to the second vehicle. This enables the second vehicle to be configured based on the profile. As a result, both the second vehicle and the first vehicle are able to be configured based on the same profile.

Still other practices include customizing interaction of the vehicle with a companion of the person.

Also among the practices are those that include receiving, from the access controller, biometric data acquired from a companion of the person. In such cases, the profile is a composite profile that includes a profile of the person and a profile of the companion. Providing the profile to the vehicle enables the companion to interact with the vehicle in a manner based on the profile of the companion.

Still other practices include, based on information in the profile, customizing a spoken greeting and causing the vehicle to deliver the customized spoken greeting.

In another aspect, the invention features a cloud service that is in communication with each vehicle in a fleet of vehicles. Each of the vehicles has an access controller that receives biometric information. The cloud service comprises a database of profiles and a profile manager. Each of the profiles comprises a profile of a person and includes information for customizing interaction between the person and any vehicle in the fleet of vehicles. The profile manager receives, from an access controller of a vehicle in the fleet, information indicating presence of the person at the vehicle, the presence having been determined based on inspection of biometric data obtained from the person. The profile manager then retrieves a profile of the person and provides the profile to the vehicle. This enables the vehicle to transition into a state that enables the person to interact with the vehicle in a manner based on the profile.

In some embodiments, the cloud service further comprises a proactive engine that receives information from the profile manager and uses that information to customize spoken interaction with the person in the vehicle.

In other embodiments, the profiles include a composite profile that includes information that enables customizing interaction of a companion to said person with said vehicle from said fleet of vehicles.

Within the claims, the terms “method” and “apparatus” shall be construed to mean a “non-abstract method” and a “non-abstract apparatus,” respectively. The claims are not intended to cover any “abstract” method and “abstract” apparatus. Any person who construes the claims as covering abstract subject matter would therefore be demonstrating the ability to construe the claims contrary to the specification.

As used herein, the term “non-abstract” shall be construed to mean the complement of “abstract” as that term has been defined by the U.S. Supreme Court and the Federal Circuit as of the filing date of this application.

These and other features of the invention will be apparent from the following detailed description and the accompanying figures, in which:

### DESCRIPTION OF DRAWINGS

FIG. 1 shows a fleet of vehicles, each equipped to receive biometric data and to communicate with a cloud service.

FIG. 2 shows details of a vehicle from the fleet shown in FIG. 1.

FIG. 3 shows details of the cloud service and the head unit shown in FIG. 2.

### DETAILED DESCRIPTION

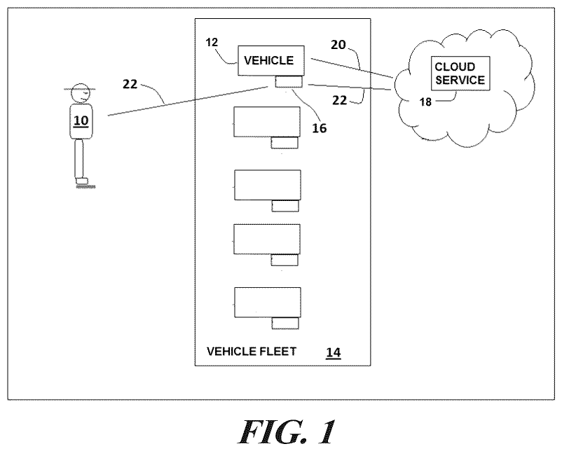

FIG. 1 shows a person 10 who seeks access to a vehicle 12 that is one of several vehicles in a vehicle fleet 14. Each vehicle 12 includes a biometric sensor 16. The vehicles are all in communication with a cloud service 18 that provides an access signal 20 to a vehicle 10 based in part on biometric data 22 received by the biometric sensor 16 at that vehicle 10. The cloud service 18 comprises one or more cloud servers.

In the illustrated embodiment, the biometric sensor 16 is configured to receive biometric data 22 from the person 10 while the person 10 stands outside the vehicle 12. This is useful for embodiments in which the vehicle 10 is kept locked. In other embodiments, the biometric sensor 16 is instead disposed to receive biometric data 22 from a person 10 who is already seated within the vehicle 12. This allows the person 10 to be sheltered from the elements during the authentication process.

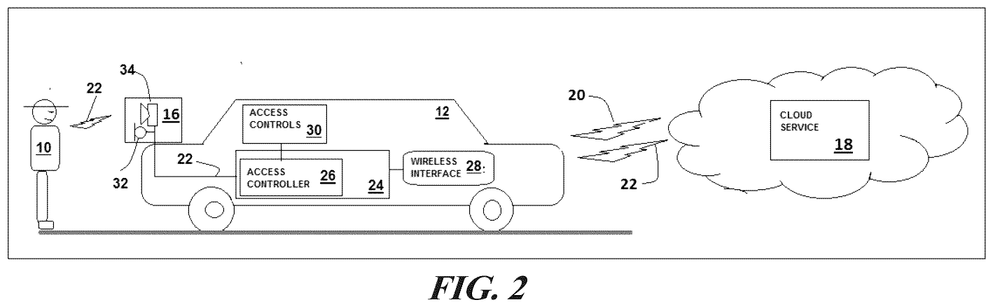

As shown in FIG. 2, a typical vehicle 10 includes a head unit 24 that executes certain applications. Among these applications is an access controller 26 that receives biometric data 22 from the biometric sensor 16 and that also communicates with the cloud service 18 via a wireless interface 28. When deemed appropriate, the access controller 26 also sends signals to access controls 30 to permit the vehicle 10 to be unlocked and/or started.

The biometric sensor 16 shown in FIG. 2 features the combination of a microphone 32 and a camera 34. However, embodiments include those in which the biometric sensor 16 consists of any combination of one or more of a camera 34, a microphone 32, a touch sensor for sensing of fingerprints, and an iris sensor that inspects a human iris. Embodiments of a camera 34 include infrared cameras and RGB cameras.

In some embodiments, the biometric sensor 16 is a smartphone carried by the person 10. This allows controlling access to the vehicle 12 based on biometric data 22 for those cases in which the vehicle 12 lacks any sort of biometric sensor 16 but nevertheless is able to provide its location to the cloud service 18 using the wireless interface 24.

In a typical case, the person's smartphone also has a location sensor and biometric sensor 16 (such as a camera or microphone). For the case in which face recognition is used, the person 10 provides biometric data 22 by taking a selfie and providing that selfie, along with the smartphone's location information, to the cloud service 18.

The cloud service 18 obtains the vehicle's location information and correlates it with the location information of the smartphone. From this, the cloud service 18 infers which vehicle 12 in the fleet 14 the person 10 seeks to access. The cloud service 18 then inspects the biometric data 22 in the selfie and renders an appropriate judgment to provide to the access controller 26.

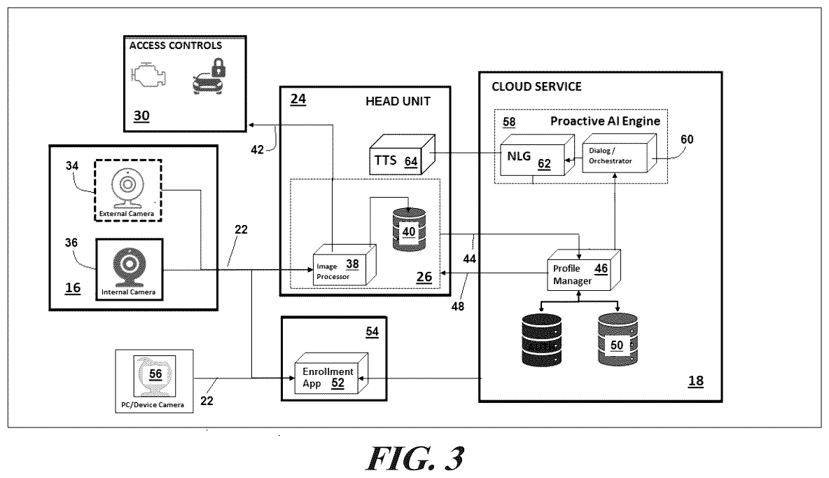

FIG. 3 shows details of the cloud service 18, the access controller 26, and the access controls 30, all of which are shown in FIG. 2. In addition, the embodiment shown in FIG. 3 has, as its biometric sensor 16, an external camera 34 and an internal camera 36. The internal camera 36 is useful for access control when the car is unlocked. In such cases, a person 10 to be identified sits in the vehicle within the internal camera's field of view. The internal camera 36 then collects the relevant biometric data 22.

The access controller 26 features an image processor 38 in communication with a local database 40. The image processor 38 receives biometric data 22 and extracts relevant features for comparison against feature sets in the local database 40.

The image processor 38 identifies a candidate feature set from the local database 40 and, based on the biometric data 22, calculates the probability that the person 10 to be identified matches the corresponding data in the candidate feature set. If this probability exceeds a pre-defined value, the access controller 26 transmits two signals: a grant signal 42, which goes to the access controls 30, and a profile request 44, which goes to the cloud service 18. By choosing the pre-defined value, it is possible to control the probability of incorrectly granting access as well as the probability of incorrectly denying access.

Upon receiving the grant signal 42 from the access controller 26, the access controls 30 carry out the relevant instruction. Examples of such instructions include unlocking the vehicle's passenger compartment, unlocking the vehicle's trunk, and enabling the engine to be started. The choice of which instruction to carry out depends on details of the grant signal 42. These details are provided by the access controller 26.

At the cloud service 18, a profile manager 46 receives the profile request 44 from the access controller 26 retrieves a profile 48 corresponding to the person 10 from a preference database 50, and relays the profile 48 back to the access controller 26. The profile 48 comprises the person's preferences, which can then be used to configure the vehicle 12. A variety of user preferences are contemplated within the profile 48. Among these are pre-sets of radio stations, pre-sets of seats and mirrors, stored music or other entertainment media, contacts, and appointments.

The foregoing interaction occurs between the cloud service 18 and any vehicle 12 in the fleet 14. As a result, the person's preferences become portable. Any vehicle 12 that the person 10 uses will import that person's 10 profile 48, thereby allowing that vehicle 12 to be customized for that person 10. Such a system is applicable not only to car sharing services or rental car companies but also for families that own more than one vehicle.

In some embodiments, the act of identifying a person 10 through facial recognition takes place outside the vehicle, using an external camera 34, either while the person 10 stands near the vehicle 12 or as the person approaches the vehicle 12. Upon successful facial recognition, the vehicle 12 carries out any one or more of various actions, such as unlocking its doors, unlocking its trunk, turning on an interior light, downloading a profile 48 corresponding to that person 10, or playing a suitable welcoming prompt via a speech interface.

In other embodiments, the act of identifying the person 10 through facial recognition takes place inside the vehicle using the internal camera 36. Such embodiments include those in which the access controller 26, upon recognizing the person 10, unlocks or even starts the engine and those in which the access controller 26, upon failing to recognize the person 10, immobilizes the vehicle 10 and, optionally, sends a message to the vehicle registered owner or driver.

The act of recognizing the person 10 requires information that correlates an observed biometric feature, such as a face, with an identity. The access controller 26 has at least two options for acquiring such information: using information provided by prior enrollment by the person 10 and using publicly available information.

In a first option, a person 10 who wishes to access vehicles 12 in the fleet 14 enrolls with the fleet's proprietor to gain such access. As part of the enrollment process, that person 10 provides biometric data 22 as part of a registration process.

The enrollment process is one that can be carried out remotely. This procedure, which is sometimes referred to as “digital onboarding,” relies on execution of an enrollment application 52 on an enrollment machine 54.

The enrollment application 52 collects relevant information and transmits it to the cloud service 18. Since the relevant information includes biometric data 22, it is particularly useful for the enrollment machine 54 to have a biometric input, such as a camera 56, for recording the person's face for facial recognition, or a microphone, for recording a sample of the person's voice for use as a voiceprint.

In the illustrated embodiment, the enrollment machine 54 is a device that is separate from the vehicle 12. An enrollment machine 54 of this type communicates directly with the cloud service 18. As a result, it is possible to carry out the enrollment process without having to access the vehicle 12. Examples of such an enrollment machine 54 includes a personal computer, a smartphone, and a tablet.

In those cases in which enrollment is carried out remotely from any vehicle 12, the biometric data obtained during enrollment will be at the cloud service 18. This biometric data would have to find its way to the local database 40 of the relevant vehicle 12. In the context of a vehicle fleet 14, one would expect a particular vehicle 12 in the fleet 14 to be assigned to the user 10. In such cases, the act of assigning a vehicle 12 to a user 10 would include having the cloud service 18 transfer appropriate biometric data to that vehicle's local database 40. As a result, when the user 10 approaches that vehicle 10, the biometric data will be available to the access controller 26.

In other embodiments, the head unit 24 itself executes the enrollment application 52. In such embodiments, enrollment requires the user 10 to access the vehicle 12.

In still other embodiments, the enrollment process includes cooperation between the head unit 24 and a device that is separate from the vehicle 12. Examples of such devices include a personal computer, a smartphone, and a tablet.

In a second option, the access controller 26 instead relies on publicly available information. Many publicly available sites have images of people's faces. Examples of such sites include “LINKEDIN®” and “FACEBOOK®.” In such cases, the internal camera 36 acquires an image and the access controller 26 sends a signal to the cloud service 18 requesting a match.

The cloud service 18 further includes a proactive engine 58 that includes a dialog orchestrator 60 in communication with a natural language generator 62. The dialog orchestrator 60 receives information from the profile manager 46 concerning the relevant profile 48 and details of the profile request 44. Based on this information, the dialog orchestrator 60 causes the natural language generator 62 to deliver an appropriate message to a text-to-speech module 64 within the head unit 24 for delivery within the vehicle 12.

In some cases, the enrollment process includes enrolling a set of people. The resulting “enrollment set” includes the user 10 as well as one or more other persons who are authorized to use the vehicle 12 or who are expected to occasionally ride in the vehicle 12. Examples of such persons include members of the user's family, including children of the user 10. The resulting profile 48 in such cases includes preferences for each person in the enrollment set. Such a profile 48 is therefore a “composite” profile 48.

Information available in the profile request 46 includes information concerning the presence of any person who is in the enrollment set. Since the profile 48 includes preferences for each person in the enrollment set, it becomes possible to customize the vehicle 12 to accommodate the preferences of all persons who are identified in the profile request 46 as being members of the enrollment set. This makes it possible to also set preferences not only for the user 10 but for anyone else in the enrollment set who happens to be accompanying the user 10. Such preferences include all of the preferences as described above in connection with the user 10. In addition, such information makes it possible for the proactive engine 58 to customize a welcome message so that it recognizes the existence of the user's companion with a suitable greeting.

In the case of seat adjustment, it is useful to know, for each person in the enrollment set, where that person will be sitting. In a vehicle 12 equipped with external cameras 34, it is possible to observe the trajectories of the individual persons as they approach the vehicle 12 and make their way to individual doors of the vehicle 12. This provides some basis for proactively determining which seats to adjust and how to adjust them.

Having described the invention and a preferred embodiment thereof, what is claimed as new and secured by letters patent is:

What is claimed is:

1. A method comprising customizing interaction of a person with a vehicle from a fleet of vehicles, wherein customizing said interaction comprises
receiving, from an access controller in said vehicle, biometric data, said biometric data having been acquired from said person,
using said biometric data, retrieving a profile for said person, and
providing said profile to said vehicle, thereby enabling said vehicle to transition into a state that enables said person to interact with said vehicle in a manner based on said profile.

2. The method of claim 1, wherein identifying said person comprises obtaining reference data for comparison with said test data, wherein said reference data comprises information indicative of facial features of said person,
said reference data having been provided by said person during an enrollment process.

3. The method of claim 1, wherein identifying said person comprises obtaining reference data for comparison with said test data, wherein said reference data comprises information indicative of facial features of said person,
said reference data having been obtained by said cloud service from publicly available images of said person.

4. The method of claim 1, wherein receiving said test data comprises receiving test data that is based on an image of said person that was obtained by an internal camera of said vehicle while said person was inside said vehicle.

5. The method of claim 1, wherein receiving said test data comprises receiving test data that is based on an image of said person that was obtained by an external camera of said vehicle while said person was outside said vehicle.

6. The method of claim 1, wherein receiving said test data comprises receiving test data that is based on an image of said person that was obtained by an external camera of said vehicle while said person was approaching said vehicle.

7. The method of claim 1, wherein receiving said test data comprises receiving test data that is based on an image of said person that was obtained by a camera of a smartphone.

8. The method of claim 1, further comprising, after said person has been identified, adjusting seating in said vehicle based on said profile.

9. The method of claim 1, further comprising, after said person has been identified, adjusting settings in an infotainment system of said vehicle based on said profile.

10. The method of claim 1, wherein said vehicle is a first vehicle of a fleet that comprises a second vehicle, wherein said method further comprises receiving, from an access controller in said second vehicle, test data, said test data being representative of an image of said person's face, using said test data, identifying said person, after having identified said person, retrieving a profile for said person and providing said profile to said second vehicle, thereby enabling said second vehicle to be configured based on said profile, wherein said second vehicle and said first vehicle are configured based on said profile.

11. The method of claim 1, further comprising customizing interaction of said vehicle with a companion of said person.

12. The method of claim 1, further comprising receiving, from said access controller, biometric data acquired from a companion of said person, wherein said profile is a composite profile that includes a profile of said person and a profile of said companion, and wherein providing said profile to said vehicle enables said companion to interact with said vehicle in a manner based on said profile of said companion.

13. The method of claim 1, further comprising, based on information in said profile, customizing a spoken greeting and causing said vehicle to deliver said spoken greeting.

14. An apparatus comprising a cloud service that is in communication with each vehicle in a fleet of vehicles, each of which comprises an access controller that receives biometric information, wherein said cloud service comprises a database of profiles and a profile manager, wherein each of said profiles comprises a profile of a person, wherein each of said profiles includes information for customizing interaction between said person and any vehicle in said fleet of vehicles, wherein said profile manager receives, from an access controller of a vehicle in said fleet, information indicating presence of said person at said vehicle, said presence having been determined based on inspection of biometric data obtained from said person, wherein said profile manager retrieves said profile of said person and provides said profile to said vehicle, thereby enabling said vehicle to transition into a state that enables said person to interact with said vehicle in a manner based on said profile.

15. The apparatus of claim 14, wherein said cloud service further comprises a proactive engine that receives information from said profile manager and uses said information to customize spoken interaction with said person in said vehicle.

16. The apparatus of claim 14, wherein said profiles comprise a composite profile that includes information that enables customizing interaction of a companion to said person with said vehicle from said fleet of vehicles.
